(19) United States
(12) Patent Application Publication
(10) Pub. No.: US 2007/0116511 A1
(43) Pub. Date: May 24, 2007

(54) Articulated Coupling Joint

(75) Inventors: Max Schlar, Guetersloh (DE); Andreas Krome, Oberreichenbach (DE); John Yorick, Belmont, NC (US)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 11/420,541

(22) Filed: May 26, 2006

Related U.S. Application Data
(60) Provisional application No. 60/686,523, filed on Jun. 1, 2005.

(51) Int. Cl. F16C 11/00

(52) U.S. Cl. 403/122

(57) ABSTRACT

An articulated coupling joint (1) for rail vehicles comprises a first coupling part (2) which has an outer surface (4) which is curved in the form of a spherical surface and forms a first contact face (5), and comprises a second coupling part (3) which has an inner surface (7) corresponding to the outer surface (4) and forming a second contact face (6) and has a holding ring (10) which is suitable for producing a welded connection to a connecting structure, the coupling parts (2, 3) being pivotable relative to one another, and a sealing ring (8, 8′) which contacts both coupling parts (2, 3) being provided for protecting the contact faces (5, 6) of the coupling parts (2, 3).

### FIELD OF THE INVENTION

The invention relates to an articulated coupling joint for rail vehicles, having a first coupling part with a spherical outer surface and having a second coupling part with a hollow spherical inner surface.

### BACKGROUND OF THE INVENTION

An articulated coupling joint for rail vehicles is for example known from U.S. Pat. No. 5,172,819 A. Said articulated coupling joint is provided for the semi-permanent connection of individual wagons. A disadvantage of the known articulated coupling joint is that the sliding surface between the two coupling parts can easily become dirty and is thus subject to a high level of wear. In addition, the connection of the outer second coupling part, which encloses the spherical first coupling part, to a connecting structure of the rail vehicle is of complex design.

### SUMMARY OF THE INVENTION

The invention is based on the object of specifying an articulated coupling joint for rail vehicles which, while being of structurally simple design, has a particularly low susceptibility to wear.

According to the invention, said object is achieved by means of an articulated coupling joint having the features of claim 1. Said articulated coupling joint has two coupling parts, specifically a first coupling part having an outer face which is curved in the form of a spherical surface, and a second coupling part having a hollow spherical inner surface. The two coupling parts are pivotable relative to one another, the outer surface of the first coupling part and the inner surface of the second coupling part respectively forming a first and a second contact face. It is possible, on account of the spherical shape of the corresponding contact faces, for the coupling parts to be pivoted relative to one another in different spatial directions. In order to counteract dirt accumulation and thus wear of the contact face between the coupling parts, at least one sealing ring which contacts both of the coupling parts is provided. In addition, at least one holding ring is arranged on the substantially cylindrical-casing shaped outer face of the second coupling part, said holding ring facilitating a welded connection to a connecting structure.

The conflicting objectives resulting from the demands both for a materially cohesive, space-saving, permanent connection of the second, outer coupling part to a connecting structure and also for a design of the contact faces which is insusceptible to dirt accumulation can be resolved in various ways: on the one hand, it is possible to produce the sealing ring from a material which can withstand the temperatures which occur as the holding ring is welded to the connecting structure. In this case, the sealing ring is inserted into the second coupling part before the latter is coupled to the first coupling part. On the other hand, it can be provided that the sealing ring is not mounted until after the two coupling parts have been coupled and after the second coupling part has been welded to the connecting structure. Irrespective of the design of the sealing rings, two similar sealing rings are preferably arranged symmetrically about a central plane of the articulated coupling joint. The same applies for two weldable holding rings at the outer circumference of the second, outer coupling part.

According to a first preferred embodiment, the at least one sealing ring is inserted in a positive-fitting manner into a groove of the second coupling part. Here, the groove can either be shaped in such a way that it is possible to insert the sealing ring when the coupling parts are coupled or in such a way that the sealing ring can be inserted in the groove exclusively if the spherical surface of the first coupling part has not yet been placed in contact with the inner surface of the second coupling part. The latter variant has the advantage in particular that in an operational articulated coupling joint, the sealing ring is fundamentally prevented from being detached from the groove.

According to a second, particularly preferred embodiment, the sealing ring is produced from an elastic, in particular foamed material which performs the intended sealing function irrespective of the relative position of the two coupling parts. While, according to the first exemplary embodiment, the sealing ring is fixedly connected to one of the coupling parts and slides on the surface of the other coupling part, according to the second exemplary embodiment, different surface regions of the sealing ring respectively permanently bear against the first and the second coupling parts. During a pivoting movement of the first coupling part relative to the second coupling part, said surface regions of the sealing ring thus remain in an unchanged position relative to the respective coupling part, while partial volumes of the sealing ring are compressed or expanded. In comparison to the first exemplary embodiment, the sealing ring according to the second exemplary embodiment is of significantly greater volume. The cross-section of the sealing ring according to the second exemplary embodiment preferably widens in the outward direction, that is to say in the direction of the circumference of the second coupling part, in a V shape. The outer diameter of the sealing ring is preferably at least 1.5 times, in particular more than double, its inner diameter. The sealing ring preferably extends radially at least approximately as far as the weldable holding ring which is to be connected to the second coupling part.

As an alternative or in addition to the embodiments described above, it is also possible to obtain sealing between the first coupling part and the second coupling part by means of rolling bellows, V-ring seals or equivalent seals. This also makes it possible for a sealing element not to adjoin a coupling part directly but rather to adjoin a further part, which is connected to the coupling part, and thus to enclose a larger space around the coupling parts. Irrespective of the embodiment of the seal or seals, the coupling parts can preferably be tilted by at least ±7°, in particular by at least ±12°, relative to one another in at least one spatial direction.

One exemplary embodiment of the invention is explained in more detail in the following on the basis of a drawing.

### Brief description of the drawing

FIGS. 1 to 4 show various sections and a perspective view of an articulated coupling joint for rail vehicles.

FIGS. 5 and 6 show a section and a perspective view of a holding ring of the articulated coupling joint according to FIGS. 1 to 4.

FIG. 7 shows a section of an alternative exemplary embodiment of an articulated coupling joint for rail vehicles.

### Detailed description of the drawing

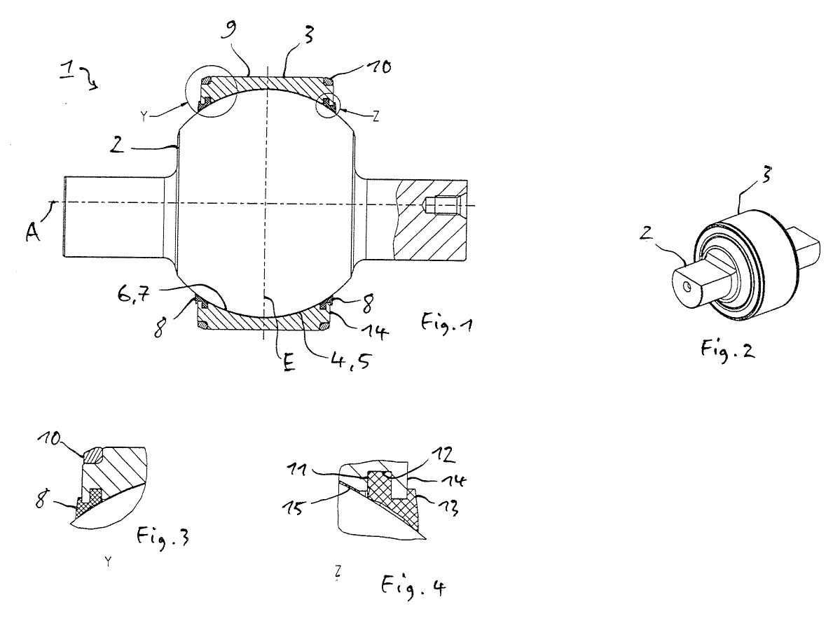

FIGS. 1 and 2 show an articulated coupling joint 1 for rail vehicles, in particular for the semi-permanent coupling of wagons, which is composed of a first, inner coupling part 2 and a second, outer coupling part 3. In FIG. 2, an axis of symmetry is denoted by A, and a plane of symmetry or central plane is denoted by E. The first coupling part 2 partly has a spherical shape, the second coupling part 3 partly has a corresponding hollow spherical shape. An outer surface 4 of the first coupling part 2 forms a first contact face 5 which bears against a second contact face 6 formed by an inner surface 7 of the second coupling part 3. The inner surface 7 of the second, outer coupling part 3 is delimited at both sides, symmetrically about the plane of symmetry E, by in each case one sealing ring 8. The sealing rings 8 prevent dirt accumulation and thus increased wear of the contact faces 5, 6. A material pairing of metal/plastic, in particular hard chrome/PTFE woven fabric, is preferably used for the contact faces 5, 6.

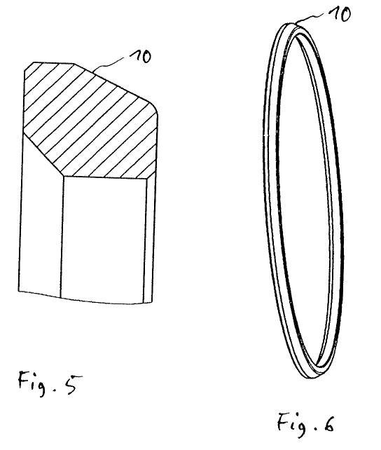

Two holding rings 10 are arranged such that they are coaxial with respect to the sealing rings 8 and adjoin a substantially cylindrical-casing shaped outer face 9 of the second coupling part 3, said holding rings 10 making it possible to produce a welded connection of the second coupling part 3 to a connecting structure (not illustrated here). The shape of the sealing rings 8 and of the holding rings 10 can be seen in detail from FIGS. 3 to 6. The sealing ring 8 forms a tongue-and-groove connection with the second coupling part 3, a first tongue strip 11 engaging radially in a groove 12 of the second coupling part 3, while a strip 13 of the sealing ring 8 bears against the outside of a side face 14, which is arranged parallel to the plane of symmetry E, of the second coupling part 3. In this way, when the articulated coupling joint 1 is assembled, the sealing ring 8 is captively held between the coupling parts 2, 3 without any further securing elements. The second coupling part 3 is also denoted as an outer ring, and is preferably hardened and split. A sliding layer 15, which is made from, for example, PTFE (polytetrafluoroethylene) and forms the contact face 6 of the outer coupling part 3, cannot be seen when the articulated coupling joint 1 is fully assembled, and is permanently protected by the sealing rings 8.

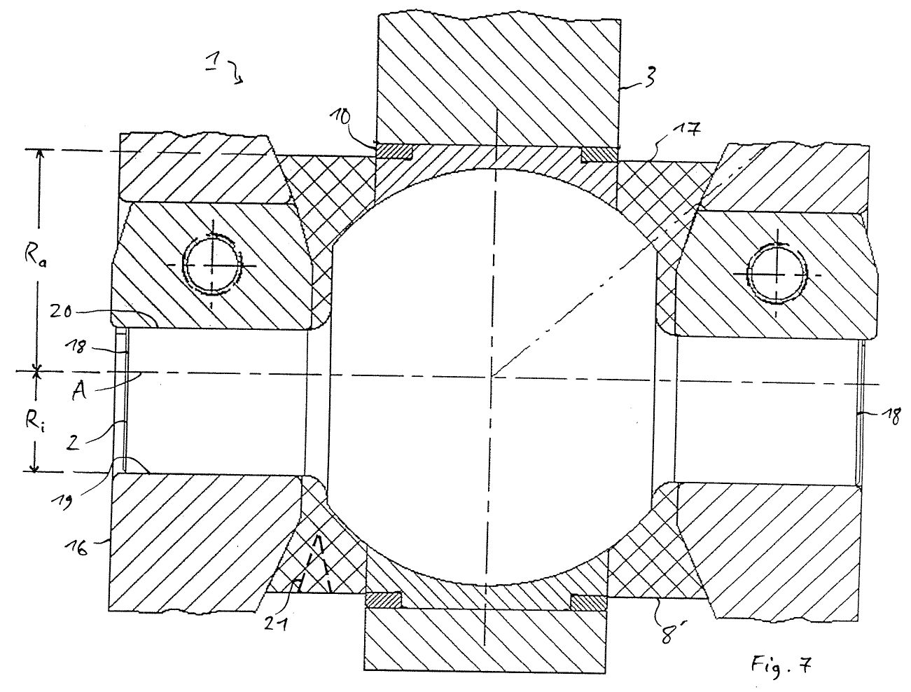

In the exemplary embodiment according to FIG. 7, the function of the sealing rings 8 is assumed by two sealing rings 8′ which are also denoted as half-shells and are produced from cellular polyurethane elastomer. Each sealing ring 8′ adjoins the first coupling part 2, the second coupling part 3, and a connecting part 16 which is fixedly connected to the first coupling part 2, wherein a substantially V-shaped space, which is filled by the sealing ring 8′, is formed between the connecting part 16 and the first coupling part 2 in the illustrated cross-section. The corresponding widening portion of the sealing ring 8′ is matched to the relative mobility of the coupling parts 2, 3. While the sealing ring 8′ has a cylindrical outer casing 17, the inner contour, which faces the axis of symmetry A, of the sealing ring 8′ deviates from the circular shape in a manner adapted to substantially cylindrical connecting pieces 18, which are however flattened at one side (at the top side in the illustration), of the first coupling part 2. In a variation of the illustrated exemplary embodiment, the sealing ring 81 could also have a completely rotationally symmetrical shape, wherein a hollow space would be produced in this case between the inner edge 19 of the sealing ring 81 and the flattened surface 20 of the connecting piece 18. In any case, the maximum inner radius Rᵢ of the sealing ring 8′ is no more than half of the outer radius Rₐ measured at the outer casing 17. In one particularly material-saving embodiment, which additionally ensures that the sealing ring 8′ can be very easily deformed and thus the first coupling part can be easily tilted relative to the second coupling part, the sealing ring 8′ has a notch 21, which is V-shaped in cross-section, at its circumference, as is indicated by way of example in one of the sealing rings 8′ in the illustration.

The outer radius Rₐ of the elastic sealing ring 8′, which accommodates all the relative movements of the coupling parts 2, 3, is no more than 20%, in particular no more than 10%, smaller than the inner diameter of the holding ring 10, and exceeds said inner diameter by no more than 50%, said holding ring 10 serving for producing a welded connection of the articulated coupling joint 1 to a connecting structure 21. It is not necessary for the sealing rings 8′, which are formed as half-shells in this so-called external sealing solution, to be particularly temperature-resistant since said sealing rings 8′ are not mounted until after the otherwise complete articulated coupling joint 1 has been welded to the connecting structure.

### List of Reference Symbols

1 Articulated coupling joint
2 Inner coupling part
3 Outer coupling part
4 Outer surface
5 Contact face
6 Contact face
7 Inner surface
8 Sealing ring
9 Outer face
10 Holding ring
11 Tongue strip
12 Groove
13 Strip
14 Side face
15 Sliding layer
16 Connecting part
17 Outer casing
18 Connecting piece
19 Inner edge
20 Surface
21 Notch
A Axis of symmetry
E Central plane
Rᵢ Inner radius
Rₐ Outer radius

1. An articulated coupling joint for rail vehicles, having a first coupling part (2) which has an outer surface (4) which is curved in the form of a spherical surface and forms a first contact face (5), and having a second coupling part (3) which has an inner surface (7) corresponding to the outer surface (4) and forming a second contact face (6) and has a holding ring (10) which is suitable for producing a welded connection to a connecting structure, the coupling parts (2, 3) being pivotable relative to one another, and a sealing ring (8, 8′) which contacts both coupling parts (2, 3) being provided for protecting the contact faces (5, 6) of the coupling parts (2, 3).

2. The articulated coupling joint as claimed in claim 1, wherein two sealing rings (8, 8′) are arranged symmetrically about a central plane (E) of the coupling parts (2, 3).

3. The articulated coupling joint as claimed in claim 1 or 2, wherein the sealing ring (8) is immobile relative to one of the coupling parts (2, 3).

4. The articulated coupling joint as claimed in claim 3, wherein the sealing ring (8) is held in a positive-fitting manner in a groove (12) of the second coupling part (3).

5. The articulated coupling joint as claimed in claim 1 or 2, wherein the sealing ring (8′) is produced from an elastic material which performs the sealing function irrespective of the relative position of the two coupling parts (2, 3), different surface regions of the sealing ring (8′) in each case being in contact with constant surface regions of the coupling parts (2, 3) when the coupling parts (2, 3) are pivoting.

6. The articulated coupling joint as claimed in claim 5, wherein the width of the sealing ring (8′) increases with increasing distance from an axis of symmetry (A) of the coupling parts (2, 3).

7. The articulated coupling joint as claimed in claim 6, wherein the outer radius (Rₐ) of the sealing ring (8′) is at least 1.5 times the inner radius (Rᵢ) of the sealing ring (8′).

8. The articulated coupling joint as claimed in claim 6 or 7, wherein the sealing ring (8′) has a V-shaped widening portion which is directed outward with respect to the axis of symmetry (A).

9. The articulated coupling joint as claimed in one of claims 1 to 8, wherein the coupling parts (2, 3) can be tilted by ±7° relative to one another in at least one spatial direction.
